(19) United States
(12) Patent Application Publication
(10) Pub. No.: US 2018/0322457 A1
(43) Pub. Date: Nov. 8, 2018

(54) ONLINE SAFETY FOR USER COLLABORATION

(71) Applicant: Hey Platforms DMCC, Dubai (AE)

(72) Inventors: Nadim Basha bin Mohamed Al Qubaisi, Dubai (AE); Anthony Webb, Dubai (AE); Anthony Stephen Clarke, Dubai (AE); Darryl Haydn Jones, Dubai (AE)

(21) Appl. No.: 15/585,452

(22) Filed: May 3, 2017

(51) Int. Cl. G06Q 10/10; H04L 29/06; G06F 21/62; G06Q 50/26; G06Q 50/00; H04L 29/08

(52) U.S. Cl. CPC G06Q 10/101; H04L 63/0421; G06F 21/6263; G06Q 50/265; G06F 21/313; H04L 67/306; H04L 65/403; H04L 65/1069; G06Q 50/01

(57) ABSTRACT

A collaboration database and server correlates project originators with collaborative responders based on a predetermined criteria of skills and background coupled with a corresponding profile of the responder that indicates possible agreement with the predetermined criteria. Communicative messaging is limited during consideration of the criteria, and full communication is permitted only after both the originator and responder have indicated sufficient skills, performance history and motivation for moving forward.

### BACKGROUND

In the music industry, there is much collaboration between artists having varied talents. Songwriters, composers, musicians of various instruments, and others often work together to create a single marketable piece, such as a track. There is often much fluidity in the industry, as contributors of varied talents move among different projects. For all but the most established and popular bands, studio musicians often appear in various songs or tracks of authored under labels, artists or bands, and not necessarily always with the same group.

### SUMMARY

A collaboration database and server correlates project originators with collaborative responders based on a predetermined criteria of skills and background coupled with a corresponding profile of the responder that indicates possible agreement with the predetermined criteria. Communicative messaging is limited during consideration of the criteria, and full communication is permitted only after both the originator and responder have indicated sufficient skills, performance history and motivation for moving forward.

The collaboration system, method an apparatus as disclosed herein is particularly suited to the music industry. The music industry thrives on a robust mix of talents. While notable and extremely talented artists may have success with a single instrument or voice alone, most successful musical endeavors are the product of multiple musicians, composers and songwriters. While the advent of CDs and digital recordings have somewhat eroded the “album” concept of past decades, the unit of deliverables continues to be an individual song or track, typically a 3-5 minute rendering of melody, lyrics, and often accompanied by a video component. The track continues to be the atomic unit of delivery for many commercial outlets, such as ITUNES®, SPOTIFY® and AMAZON®, which provide electronic delivery of music tracks on a fee for services basis.

Configurations herein are based, in part, on the observation that electronic interfaces, such as websites and online systems, allow exchanges of sensitive and personal information with little information or protection on the remote party to whom such information is disclosed. Unfortunately, while the ability to readily exchange information with interested parties is enhanced by Internet communications, the anonymity and unaccountability can also impede efforts to deter or avoid communication that may be deemed annoying, abusive or compromising. While undesirable communication may range from mere annoyances to outright safety concerns through divulged personal information, it would be beneficial to provide oversight to online exchanges of information to allow appropriate communication and exchanges for mutually beneficial endeavors without exposing sensitive information prematurely.

Online outlets are known for socially based exchanges, including FACEBOOK and INSTAGRAM that promote sharing among groups of people, as well as so-called “dating” sites that are directed to individual exchanges for specific social goals. Commercial exchanges are also facilitated by sites such as CRAIGSLIST which are directed to commercial exchanges. The social media sites often mediate sensitive information through a third party operator of the website, which retain accountability information on contributors, however these sites are not suited for commercial or monetary endeavors. Conversely, CRAIGSLIST connects parties to a monetary exchange, but does little to facilitate and exchange without divulging contact information necessary to enable a transaction. It would be beneficial to provide an online exchange forum to allow for artistic collaboration without requiring parties to completely divulge contact information until sufficient assurances of a mutually beneficial exchange is established.

Accordingly, configurations herein substantially overcome the shortcomings associated with seeking online collaboration by providing an approach that allows parties to exchange collaboration parameters for identifying a symbiotic agreement without prematurely divulging personal contact information. In contrast to conventional social media, unsuited for pecuniary motivations, or sales based sites which are merely conduits of personal information, the disclosed approach allows a user to “push” information to a selected subset of potential collaborators rather than nonselective “pulling” of information by a general user base. Collaborators specify parameters of potential responders, and only responders meeting the parameters may indicate an interest to move forward. The parameters are based on verifiable profiles, rather than self-asserted qualifications that invite overly zealous embellishment and possible fabrication. In this manner, collaborators are provided an avenue for professional artistic exchanges while limiting exposure to respondents that have demonstrated sufficient potential to warrant the disclosure.

In further detail, the method of establishing an anonymous collaborative association via an electronic network based on symbiotic talent or skill resources includes receiving, from an originator, a collaboration request including qualification criteria indicative of attributes consistent with satisfying the collaboration request, and allowing, based on a correspondence with a skill sought in the collaboration request and a skill denoted in a user profile, a responder to view the collaboration request. A server includes a database interface and logic for permitting a response based on a correspondence of a responder with the qualification criteria. The response indicates an interest and a fit with the qualification criteria, and is indicative of a user profile corresponding to the responder and indicative of the correspondence. The responder receives, based on a perceived agreement of skills identified in the user profile, an acknowledgment message from the originator, and the server either establishes a communications accessibility between the originator and the responder, or restricts additional communication between the originator and the responder if a message to withdraw interest is received from either the originator or the responder.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a music distribution environment suitable for use with configurations herein;

FIG. 2 is a sequence diagram of a user exchange leading to collaboration in the environment of FIG. 1; and

FIG. 3 is a decision tree reflecting the process of FIG. 2.

### DETAILED DESCRIPTION

Configurations depicted below present example configurations of the disclosed approach in the form of a musician and performing artist collaboration system and website accessible by users who define originators and responders of collaboration requests. In conventional approaches, when a user wishes to collaborate in an exchange of ideas or services, opening up communication to an unknown audience frequently creates an environment where unsolicited contact can lead to online abuse. To counter this vulnerability, a structured method for initiating and terminating contact is required. The distinguishable method ensures that users will not receive initial contacts from any other user who does not meet certain criteria, and in any-case, personal messages are disallowed until the recipient actively accepts communication. Users on either side of the conversation have the freedom to terminate the discussion at any time; leaving information as to why the discussion was terminated.

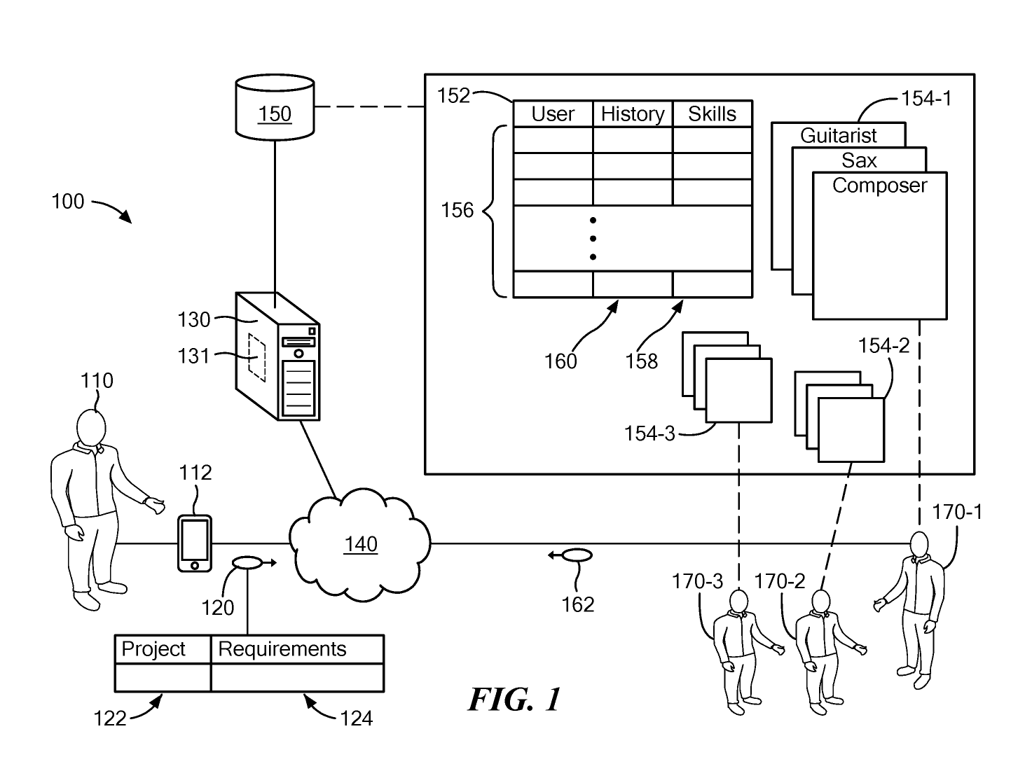

FIG. 1 is a context diagram of an artistic development and collaboration environment suitable for use with configurations herein. Referring to FIG. 1, in a music development environment 100, an originator 110 defines a project request 120 using a suitable network conversant device 112, such as a mobile phone, laptop, desktop, tablet or other communications medium defining a network interface. The project request 120 includes a project task 122 and requirements 124, or qualification criteria, expected of a responder. A collaboration server (server) 130 receives the request 120 via the Internet or other suitable public access network 140.

The server 130 maintains a database 150 including a table of users 152 and a series of profiles 154-1 . . . 154-3 (154, generally) for each user. For each user, an entry 156 denotes skills 158 and collaboration history 160 of previous endeavors. The project request 120 is compared to the table 152 to find entries 156 of users exhibiting a correspondence with the skills 158 and history 160 in the request 120. Users meeting the qualification criteria defined by the collaboration request, potential responders are permitted a response 162 based on a correspondence of the responder with the qualification criteria. A mobile device and/or any suitable GUI (graphical user interface) may be employed. The response 162 indicates an interest and a fit with the qualification criteria, and further references a user profile 154 corresponding to the responder 170-1 and indicative of the correspondence. Other responders 170-2, 170-3 (170 generally) may also contribute as responders.

Following the initial response 162, an exchange protocol driven by server logic 131 and a database 150 follows, discussed below, before free communication between the originator 110 and responder 170 is permitted. It should be noted that both the originator 110 and responder are users, as an originator 110 on one project may be a responder 170 on another. The server 130 receives, based on a perceived agreement of skills 158 identified in the user profile 154 with the collaboration request 120, an acknowledgment message from the originator 110 to the responder.170 The server 130 then establishes communications accessibility between the originator 110 and the responder 170, however at any time may restrict additional communication between the originator and the responder if a message to withdraw interest is received from either the originator 110 or the responder 170.

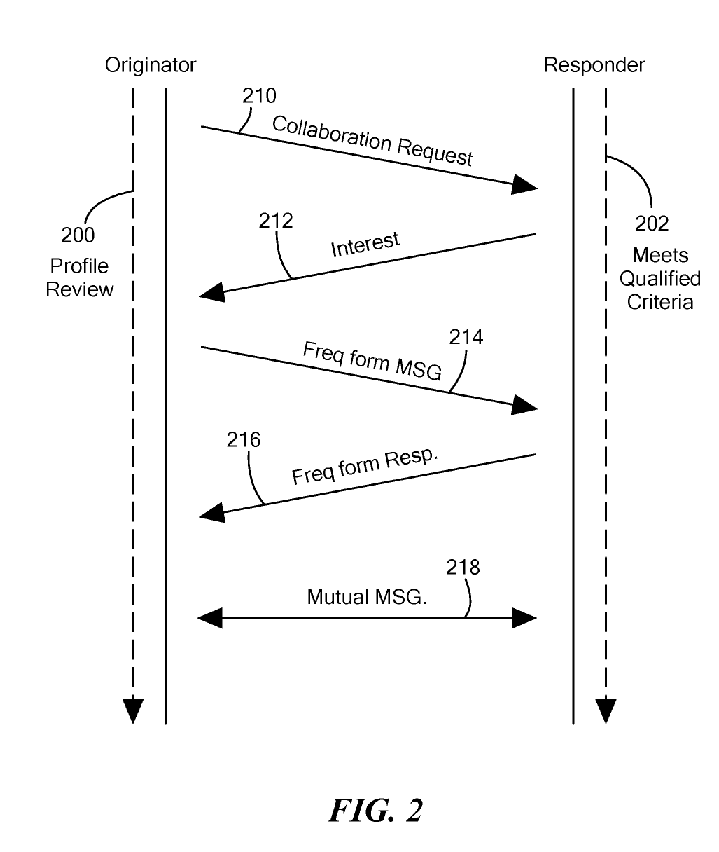

FIG. 2 is a sequence diagram of a user exchange leading to collaboration in the environment of FIG. 1. Referring to FIGS. 1 and 2, an originator timeline 200 and a responder timeline 202 depict respective actions by each. As shown at arrow 210, the server 130 receives, from the originator, the collaboration request 120 including qualification criteria indicative of attributes consistent with satisfying the collaboration request 120. The server 130 allows, based on a correspondence with a skill sought in the collaboration request 120 and a skill denoted in a user profile in the database 152, a potential responder 170 to view the collaboration request.

Based on the correspondence, the server 130 establishes a messaging contact interface through profile related exposure, by exposing a link to a profile page containing the user profile 154, shown by arrow 212. This sequence differs from conventional social or sales media by commencing communication only by a proactive insertion of a collaboration request 120 to an electronic network, and permitting responder 170 access by a match on at least one criteria in the collaboration request 120. The server 130 allows the responder 170 to pull information only from the collaboration request 120 following the match, and prevents access to the collaboration request 120 if no match is found between the collaboration request 120 and the skills 158 and profile 154 of the responder 170. Thus, potential responders 170 cannot simply browse all outstanding collaboration requests, but rather must be analyzed by the server 130 for a skill match based on a verifiable profile to confirm that a collaboration is viable.

If the originator 110 likes the profile 154, the server 120 receives a confirmation of mutual interest based on the profile page, typically as a free form text message, shown by arrow 214. Until this point, the server 130 has refrained from exposing personal contact information of either the originator 110 or the responder 170 to the other unless a communications association is established, and will continue to refrain from exposing personal contact information following a message to withdraw interest, if issued (withdrawal is discussed further below).

Once the originator 110 has sent a response 214 to the responder 170, the responder may now send free form text messages to the originator, as shown by arrow 216. Mutual anonymous text communication has now been established (step 218), and the originator 110 and responder 170 may collaborate while relying on the anonymous communication provided by the server 130 until and when it is prudent to reveal further information in privity of an agreed-upon monetary arrangement or other professional endeavor.

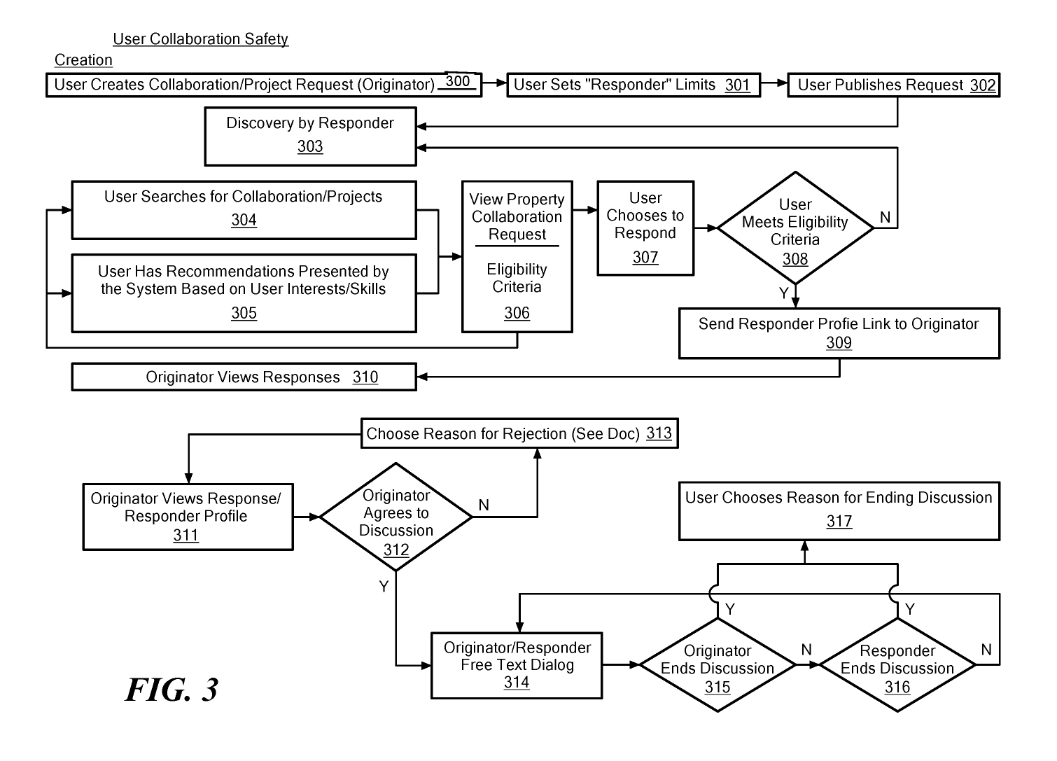

FIG. 3 is a decision tree reflecting the process of FIG. 2. Referring to FIGS. 1-3, at step 300, an originator (user) 110 creates a collaboration request 120 to call for collaboration on a project. The originator 110 may set limits on who may respond, as shown at step 301. The limits are defined by qualification criteria, which may include, for example, (but not limited to)

a. Minimum time as a member.

b. Has an “active” profile.

c. Has a verified user account.

d. Has similar interests.

e. Is located nearby.

f. Has certain skills or track-record of similar collaborations.

g. Has not received negative feedback on previous attempts to collaboration with a fellow user.

The user then publishes the request to the server 130, as depicted at step 302.

Responder access to the collaboration request 120 is based on a correlation with the qualification criteria. In the example arrangement, the qualification criteria defines a skill set indicative of music production based abilities (or other artistic endeavor) for fulfilling a collaborative effort, and characteristics including a duration of profile existence, a regularity of responses to previous collaboration requests, and authentication of an identity of the responder 170. Thus, the potential responders are limited to those with a demonstrated background to be a viable candidate for consideration. In addition, the qualification criteria may include a history including past reviews and performance based on previous collaboration requests responded to by the responder 170. Therefore, users who have demonstrated an ability to perform as suggested by their profile may nonetheless be prevented from responding.

The published collaboration request 120 is only available to potential responders 170 meeting the qualification criteria. A potential responder commences discovery, at step 303, by one of several approaches. A user may proactively search for potential collaborative projects, at step 304, or may respond to a recommendation presented by the server 130 based on the skills and interest in their profile 154, as shown at step 305.

Another aspect of analyzing the potential responder 170 includes identifying a country of which the responder is located. It may be concluded that the identified country is associated with a risk of fraud, resulting in denying acceptance of messages from the purported responder 170 due to security concerns.

At step 306, an interested user who meet the requirements of the originator (the responder 170), first clicks a control announcing their interest. After confirming the intent at step 307, the originator 110 is sent a message by the server 130 informing them of the responder's interest and providing a link to the responder's profile.154. If the user does not meet eligibility criteria, at step 308, control reverts to step 303 to continue discovery. The responder 170 can, at any time, withdraw their interest even before the originator 110 has had a chance to review the responder's profile 154. Therefore, a responder 170 is prevented from transmitting a message to the originator unless the responder has skills matching at least one skill included in the collaboration request, the originator has indicated an approval of the profile of the responder, and a request to withdraw has not been received from the originator.

The profile 154 has the effect of establishing a valid association between a responder 170 and an identity reflected in the profile page to provide assurances that the profile accurately reflects the responder 170. The profile indicates specific professional information about the responder 170, such as skills, education, previous projects, and other suitable marketing or CV (curriculum vitae) information. If beneficial, the server may fortify the profile 154 by sending a communication to a telephone number associated with the identity of the responder, or alternatively an email, skype, or other established communication thread. Such authentication proceeds by including an authenticity token in the sent communication, receiving, in a return communication, the token, and relinquishing, after a predetermined interval, the telephone number from association with the responder. This is to allow stale authenticity data to erode over time, to present false matches. Further, the true responder 170 may nonetheless have multiple accurate profiles. It is conceivable that a musician may have proficiency in, for example, guitar, saxophone, and as a composer. Multiple profiles endorsing proficiency with individual roles may be pursued, as long as each is accurately reflective of the potential of the responder 170.

At step 310, the originator 110 has an opportunity to review responses and profiles 134 of responders 170 (any eligible responders may have responded). After the originator 110 reviews the responder's profile 134, at step 311 the originator elects how to proceed with each responder at step 312. The originator 110 can send free text responses to the responder, at step 314, or dismiss the request for the following reasons (step 313):

a. The responder's profile does not fit with the originator's idea of the ideal collaborator. (Neutral dismissal)

b. The responder's profile is advertising or spam. (Dismiss as spam)

c. The responder's profile is misleading or ambiguous. (Dismiss as inappropriate)

d. Other reasons as are defined from time to time.

Once the originator 110 has sent a response to the responder 170, the responder 170 may now send free text messages to the originator 110.

The number of messages the responder 170 or originator 110 may send to each other increases over time. At first, the responder 170 may only respond to an originator's message and vice-versa. Later the originator and responder may send messages freely and without limit.

Communications may proceed until receiving, from either the originator or responder, an indication that collaboration is no longer desired. This is followed by receiving a reason for dismissal of the collaboration, preventing additional messaging between the originator and the responder, and entering the reason in the history of the dismissed responder or originator.

At any time, the originator or responder can end the conversation with a reason that is either “neutral” or one of several negative reasons, as shown at steps 315 and 316. Upon a withdrawal request, a reason for withdrawal is requested, at step 317. In general, this is to indicate whether a mutual skill fit was not optimal, or whether a particular user (originator or responder) exhibited culpable behavior. The indication that collaboration is no longer desired includes a reason defining at least one of mutual dismissal, unproductive advertising material, or inappropriate or inapplicable content, further comprising storing a series of successive reasons corresponding to the originator or responder. It should be noted that at no time is the originator's or responder's user account identity revealed, only the respective profiles 154.

The server 150 defines a network server device for establishing the anonymous collaborative association via an electronic network based on symbiotic talent or skill needs, as disclosed above. Internet connectivity, or other public or private network or intranet, may be employed using interconnected user devices using any suitable wired or wireless communication medium. Similarly, the server 150 and associated user devices 112 collectively define a system and computer readable storage medium having instructions for collaborative association as discussed above.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method of establishing an anonymous collaborative association via an electronic network based on symbiotic talent or skill needs, comprising:
receiving, from an originator, a collaboration request, the collaboration request including qualification criteria indicative of attributes consistent with satisfying the collaboration request;
allowing, based on a correspondence with a skill sought in the collaboration request and a skill denoted in a user profile, a responder to view the collaboration request;
permitting a response based on a correspondence of a responder with the qualification criteria, the response indicating an interest and a fit with the qualification criteria, the response indicative of a user profile corresponding to the responder and indicative of the correspondence;
receiving, based on a perceived agreement of skills identified in the user profile with the collaboration request, an acknowledgment message from the originator to the responder;
establishing a communications accessibility between the originator and the responder; and
restricting additional communication between the originator and the responder if a message to withdraw interest is received from either the originator or the responder.

2. The method of claim 1 wherein the qualification criteria defines:
a skill set indicative of music production based abilities for fulfilling a collaborative effort;
characteristics including a duration of profile existence, a regularity of responses to previous collaboration requests, and authentication of an identity of the responder; and
a history including past reviews and performance based on previous collaboration requests responded to by the responder.

3. The method of claim 1 further comprising establishing a messaging contact interface through profile related exposure, further including:
exposing a link to a profile page containing the user profile; and
receiving a confirmation of mutual interest based on the profile page.

4. The method of claim 1 wherein a responder is prevented from transmitting a message to the originator unless:
the responder has skills matching at least one skill included in the collaboration request;
the originator has indicated an approval of the profile of the responder; and
a request to withdraw has not been received from the originator.

5. The method of claim 3 further comprising:
establishing a valid association between a responder and an identity reflected in the profile page by sending a communication to a telephone number associated with the identity;
including an authenticity token in the sent communication;
receiving, in a return communication, the token; and
relinquishing, after a predetermined interval, the telephone number from association with the responder.

6. The method of claim 5 further comprising:
identifying a country of which the responder is located;
concluding that the identified country is associated with a risk of fraud; and
denying acceptance of messages from the responder.

7. The method of claim 2 further comprising:
receiving, from either the originator or responder, an indication that collaboration is no longer desired;
receiving a reason for dismissal of the collaboration;
preventing additional messaging between the originator and the responder; and
entering the reason in the history of the dismissed responder or originator.

8. The method of claim 7 wherein the indication that collaboration is no longer desired includes a reason defining at least one of mutual dismissal, unproductive advertising material, or inappropriate or inapplicable content, further comprising storing a series of successive reasons corresponding to the originator or responder.

9. The method of claim 1 further comprising:
commencing communication only by a proactive insertion of a collaboration request to an electronic network;
permitting responder access by a match on at least one criteria in the collaboration request;
allowing the responder to pull information from the collaboration request following the match; and
preventing access to the collaboration request if no match is found between the collaboration request and the profile of the responder.

10. The method of claim 1 further comprising:
refraining from exposing personal contact information of either the originator or the responder to the other unless a communications association is established; and
continuing to refrain from exposing personal contact information following a message to withdraw interest.

11. A network server device for establishing an anonymous collaborative association via an electronic network based on symbiotic talent or skill needs, comprising:
a network interface for receiving, from an originator, a collaboration request, the collaboration request including qualification criteria indicative of attributes consistent with satisfying the collaboration request;
a user interface for allowing, based on a correspondence with a skill sought in the collaboration request and a skill denoted in a user profile, a responder to view the collaboration request;
server logic for permitting a response based on a correspondence of the responder with the qualification criteria, the response indicating an interest and a fit with the qualification criteria, the response indicative of a user profile corresponding to the responder and indicative of the correspondence; and
a user interface to receive, based on a perceived agreement of skills identified in the user profile with the collaboration request, an acknowledgment message from the originator to the responder;
the server logic configured to establish a communications accessibility between the originator and the responder, and further operable to restrict additional communication between the originator and the responder if a message to withdraw interest is received from either the originator or the responder.

12. The device of claim 11 wherein the qualification criteria defines:
a skill set indicative of music production based abilities for fulfilling a collaborative effort;
characteristics including a duration of profile existence, a regularity of responses to previous collaboration requests, and authentication of an identity of the responder; and
a history including past reviews and performance based on previous collaboration requests responded to by the responder.

13. The device of claim 11 wherein the server logic is configured to establish a messaging contact interface through profile related exposure, further including:
exposing a link to a profile page containing the user profile; and
receiving a confirmation of mutual interest based on the profile page.

14. The device of claim 11 wherein the server logic prevents a responder from transmitting a message to the originator unless:
the responder has skills matching at least one skill included in the collaboration request;
the originator has indicated an approval of the profile of the responder; and
a request to withdraw has not been received from the originator.

15. The device of claim 13 wherein the server logic is operable to:
establish a valid association between a responder and an identity reflected in the profile page by sending a communication to a telephone number associated with the identity;
include an authenticity token in the sent communication;
receive, in a return communication, the token; and
relinquish, after a predetermined interval, the telephone number from association with the responder.

16. The device of claim 12 wherein the server logic is configured to:
receive, from either the originator or responder, an indication that collaboration is no longer desired;
receive a reason for dismissal of the collaboration;
prevent additional messaging between the originator and the responder; and
enter the reason in the history of the dismissed responder or originator.

17. The device of claim 17 wherein the indication that collaboration is no longer desired includes a reason defining at least one of mutual dismissal, unproductive advertising material, or inappropriate or inapplicable content, further comprising storing a series of successive reasons corresponding to the originator or responder.

18. The device of claim 11 wherein the server logic is configured to:
commence communication only by a proactive insertion of a collaboration request to an electronic network;
permit responder access by a match on at least one criteria in the collaboration request;
allow the responder to pull information from the collaboration request following the match; and
prevent access to the collaboration request if no match is found between the collaboration request and the profile of the responder.

19. The device of claim 11 wherein the server logic is configured to:
refrain from exposing personal contact information of either the originator or the responder to the other unless a communications association is established; and
continue to refrain from exposing personal contact information following a message to withdraw interest.

20. A computer program product on a non-transitory computer readable storage medium having instructions that, when executed by a processor, perform a method of establishing an anonymous collaborative association via an electronic network based on symbiotic talent or skill needs the method of comprising:
receiving, from an originator, a collaboration request, the collaboration request including qualification criteria indicative of attributes consistent with satisfying the collaboration request;
allowing, based on a correspondence with a skill sought in the collaboration request and a skill denoted in a user profile, a responder to view the collaboration request;
permitting a response based on a correspondence of a responder with the qualification criteria, the response indicating an interest and a fit with the qualification criteria, the response indicative of a user profile corresponding to the responder and indicative of the correspondence;
receiving, based on a perceived agreement of skills identified in the user profile with the collaboration request, an acknowledgment message from the originator to the responder;
establishing a communications accessibility between the originator and the responder; and
restricting additional communication between the originator and the responder if a message to withdraw interest is received from either the originator or the responder.
